(19) United States
(12) Patent Application Publication
(10) Pub. No.: US 2013/0183067 A1
(43) Pub. Date: Jul. 18, 2013

(54) DEVICE, SYSTEM AND METHOD FOR PRODUCING A MAGNETICALLY INDUCED VISUAL EFFECT

(71) Applicants: Pierre Degott, Crissier (CH); Claude-Alain Despland, Prilly (CH); Mathieu Schmid, Lausanne (CH)

(72) Inventors: Pierre Degott, Crissier (CH); Claude-Alain Despland, Prilly (CH); Mathieu Schmid, Lausanne (CH)

(73) Assignee: SICPA HOLDING SA, Prilly (CH)

(21) Appl. No.: 13/825,621

(22) PCT Filed: Sep. 23, 2011
(86) PCT No.: PCT/EP11/66583

§ 371 Date: Mar. 22, 2013

(30) Foreign Application Priority Data
Sep. 24, 2010 (EP) 10010506.3

(51) Int. Cl. G03G 15/09

(52) U.S. Cl. CPC G03G 15/09
USPC 399/267

(57) ABSTRACT

The invention relates to a device, system and method for producing magnetically induced visual effects in coatings, particularly security or decorative features, containing orientable magnetic particles. The device comprises a printing unit, an orientation means, a substrate-guiding system and a photocuring unit. The printing unit is arranged to print with the coating composition an image on a first side of a substrate. The orientation means comprises a magnetic field generating element for orienting the magnetic particles in the coating composition of the printed image. The substrate-guiding system is arranged to bring and hold the substrate in contact with the orientation means. The photocuring unit irradiates the image printed on the substrate to at least partially cure the coating composition of the image while the substrate is still in contact with the orientation means. The photocuring unit is configured such that its emission of thermal radiation energy is such limited as to not heat the orientation means to an average temperature T1 exceeding 100° C.

### FIELD OF INVENTION

The present invention relates generally to the field of security elements for the protection of banknotes and documents of value or articles and specifically to a device, a system and a method for producing magnetically induced visual effects in coatings containing orientable magnetic particles.

### BACKGROUND OF THE INVENTION

Various materials and technologies for the orientation of magnetic particles in molding and coating compositions have been disclosed in e.g. US 2005/0,123,764, U.S. Pat. No. 2,418,479, U.S. Pat. No. 2,570,856, WO 2000/12,622, EP-A 0,686,675, WO 2008/153,679, US 2008/0,292,862, U.S. Pat. No. 5,364,689, US 2004/0,251,652, DE-A 2,006,848, U.S. Pat. No. 3,791,864 and WO 1998/56,596.

Orientable magnetic particles are also used in printing processes particularly for the printing of security or decorative features. In particular, the use of magnetic optically variable plate-like particles has been disclosed for the production of special visual and color-shifting effects. These devices and the technology employed to produce them are known and are described in e.g. EP-B 1,641,624, EP-B 1,819,525, EP-B 1,937,415, EP-A 1,880,866, EP-B 2,024,451, WO 2010/066,838, U.S. Pat. No. 6,759,097, WO 2002/090,002 and WO 2004/007,095.

The application of coatings containing orientable magnetic particles and the production of visual effects based on the orientation of these magnetic particles usually proceeds according to the following sequence of discrete steps:
a) applying the coating containing the orientable magnetic particles on the substrate; the coating material needs to be in a liquid state or to have a low viscosity;
b) orienting the magnetic particles by exposing the coating to a magnetic field created by an external magnetic device;
c) immobilizing the orientation of the magnetic particles by increasing the viscosity of the coating.

Step c) comprises a hardening of the coating. This step can be performed as known to the skilled person, e.g. by physical drying (evaporation of solvent), UV-curing, electron beam curing, heat-set, oxypolymerization, by combinations thereof, or by other curing mechanisms. The hardening mechanism depends on the coating material. For example U.S. Pat. No. 7,691,468 describes inks used for security features, which are dried either by hot air or by UV-curing depending on the ink composition.

The coating viscosity and the layer thickness (before and after drying) are key parameters for the orientation of the magnetic particles. To achieve the best possible effects, it is essential that the orientation of the magnetic particles is preserved until the hardening step is achieved. In printing processes, a preserved orientation of the magnetic plate-like particles ensures best possible image sharpness and the best possible overall visual effect.

U.S. Pat. No. 2,829,862 teaches the importance of the viscoelastic properties of the carrier material for preventing reorientation of the magnetic particles after the removal of the external magnet.

EP-B 2,024,451 teaches that the type of coating carrier plays a determining role in the process by affecting the final pattern through the volume change of the coated layer during the drying process: in a physical drying process, the carrier tends to reduce in volume as the solvent evaporates; this shrinking can cause a significant impact on the orientation of the flakes; carriers cured by UV process tend not to shrink as much, thus preserving the original orientation of the magnetic plate-like particles.

In addition, the type of substrate and the viscosity of the coating composition may influence the absorption of the wet coating composition by the substrate and thus the layer thickness. Thus EP 2,024,451 discloses the crucial role of the layer thickness in the use of coating composition comprising orientable magnetic plate-like particles. WO 2010/058,026 discloses the advantage of using a primer layer to reduce the absorption of the ink vehicle containing magnetic particles by porous substrates.

Keeping the coating within the magnetic field during the hardening process can preserve the orientation of the magnetic particles. For example, U.S. Pat. No. 2,570,856 teaches a process for the formation of coatings containing magnetic particles. The coated substrate is kept in the magnetic field until it is sufficiently dried to be removed from the magnetic field without reorientation of the magnetic particles. Analogous processes are disclosed in WO 2008/153,679 and U.S. Pat. No. 2,418,479.

However, all of these documents discussed above merely describe processes that are either not suitable for printing applications or that are run at speeds far below process speeds required for industrial printing applications.

WO-A 1998/56,596 discloses a method to produce some watermarks in polymeric substrates which comprises a thermal treatment of the substrate before the orientation of the magnetic particles. A final cooling down of the composition then leads to the freezing of the magnetic particles orientation.

WO-A 2004/007,095 discloses a tool for the industrial printing of security features on a substrate being an elongated thin sheet. The set-up comprises a cylinder carrying the magnetic elements and a diffuse drying energy source placed shortly after the magnetic cylinder or above it. The drying energy may be thermal and/or photochemical energy. However, this set-up shows a number of disadvantages:

(a) On the one hand various mechanical issues may occur when this set-up is used for a sheet-fed process, especially at the extremities of the sheet, e.g. shifting, sliding, folding or waving of the sheet on the cylinder, floating of the sheet extremities during the release from the cylinder. Also the tool's curing set-up does neither solve these issues nor does it describe how to address them in a sheet-fed process.

(b) On the other hand various issues related to the curing set-up may occur, particularly:
The diffuse energy source of the curing set-up may cause premature drying of the coating before optimum alignment of the magnetic particles according to the visual effect to be achieved;
The thermal aspects of the curing process and the effects, e.g. on the coating composition, that may result from the heat released by the diffuse curing energy source above the magnetic cylinder body may cause issues. Particularly, heat may decrease the viscosity of the coating composition thus favoring absorption of the coating composition by the substrate. Therefore, the heat released by the energy source may disturb the orientation of the magnetic particles and thus the visual effect to be achieved;
Heat may decrease the humidity content of the paper and thus modify the dimensions of the substrate, hence leading to registration problems. This effect is particularly critical with paper substrates and with sheet-fed process;
Heat may cause the dilatation of some mechanical constituents of the printing machine thus leading to registration problems or misalignment issues; and
Thermal energy may modify the properties of the magnetic field generating elements. The properties of magnetic materials are known to vary with temperature: the alignment of magnetic domains in ferro- and ferrimagnetic material decreases with increasing temperature. When magnetic materials are heated to a critical temperature called the Curie temperature, they become paramagnetic. The Curie temperature is a material-dependant parameter.

Therefore, there is a need for improved ways of producing magnetically induced visual effects, particularly for security or decorative features, which reduce or even avoid the above-mentioned disadvantages.

### SUMMARY OF THE INVENTION

Thus, the present invention relates to a device, a system and a method for producing magnetically induced visual effects in coatings containing orientable magnetic particles. Particularly, the invention concerns the printing and curing of security or decorative features comprising orientable magnetic particles on an industrial printing machine. Particularly the printing machine may be of a sheet-fed type.

In accordance with a first aspect of the invention a device for producing a magnetically induced visual effect according to claim 1 is provided.

The device comprises a printing unit, an orientation means, a substrate-guiding system and a photocuring unit. The printing unit is arranged to print with a coating composition containing orientable magnetic particles an image on a first side of a substrate. The orientation means comprises at least one magnetic field generating element for orienting the magnetic particles in the coating composition of the printed image. The substrate-guiding system is arranged to bring and hold a second side of the substrate in contact with the orientation means. The photocuring unit comprises a radiation source arranged with respect to the orientation means so as to irradiate the image printed on the first side of the substrate to at least partially cure the coating composition of the image while the second side of the substrate is still in contact with the said orientation means. The photocuring unit is configured such that its emission of thermal radiation energy is such limited as to not heat the orientation means and its at least one magnetic field generating element to an average temperature T1 exceeding 100° C. Due to this configuration the above mentioned negative effects on the substrate, the printed image and the device itself can be substantially reduced or avoided.

In accordance with a second aspect of the invention a system for producing a magnetically induced visual effect is provided. The system comprises a device according to the first aspect of the invention and a coating composition containing orientable magnetic particles.

In a third aspect of the invention a method for producing a magnetically induced visual effect is provided.

Preferred embodiments of the invention are provided in the dependent claims.

### BRIEF DESCRIPTION OF THE DRAWINGS

The accompanying drawings, which are incorporated in and constitute a part of this specification, illustrate certain aspects of the present invention without limiting it thereto. Particularly, the Figures show several embodiments where the orienting means is provided in the form of a cylindrical body comprising at least one magnetic field generating element, and where the substrate is a thin elongated substrate, e.g. a sheet of paper, polymer or composite substrate.

FIGS. 1-3 show schematic cross-sectional views showing the magnetic cylinder body, the curing unit and a thin elongated substrate (sheet) having images of coating composition applied thereon, according to embodiments of the present invention. Particularly,

FIG. 1 shows an embodiment where the photocuring unit comprises a UV-LED lamp;

FIG. 2 shows an embodiment where the photocuring unit comprises a UV-lamp equipped with a dichroic filter; and

FIG. 3 shows an embodiment where the photocuring unit comprises a UV-lamp equipped with a wave-guide.

FIGS. 4a-c illustrate variations of the relative timing of individual phases of the process of producing a magnetically induced visual effect, according to embodiments of the present invention.

FIG. 5 shows a schematic view of an embodiment of the present invention where the substrate-guiding system comprises a set of rollers; and

FIG. 6 shows a schematic view of an alterantive embodiment of the present invention where the substrate-guiding system comprises a set of brushes.

### DETAILED DESCRIPTION OF THE INVENTION

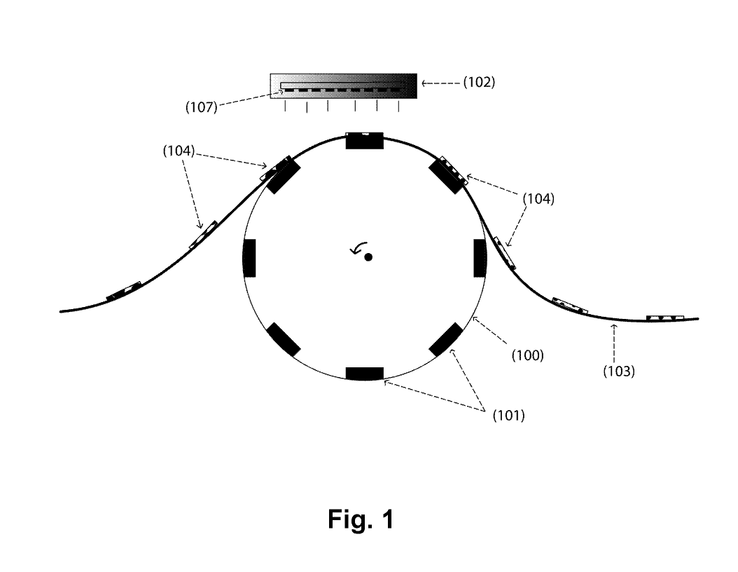

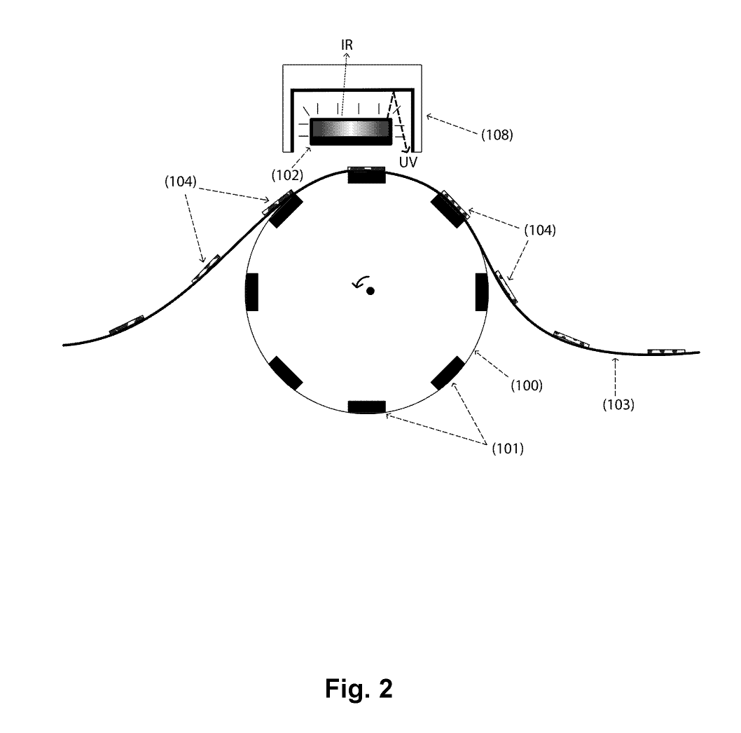

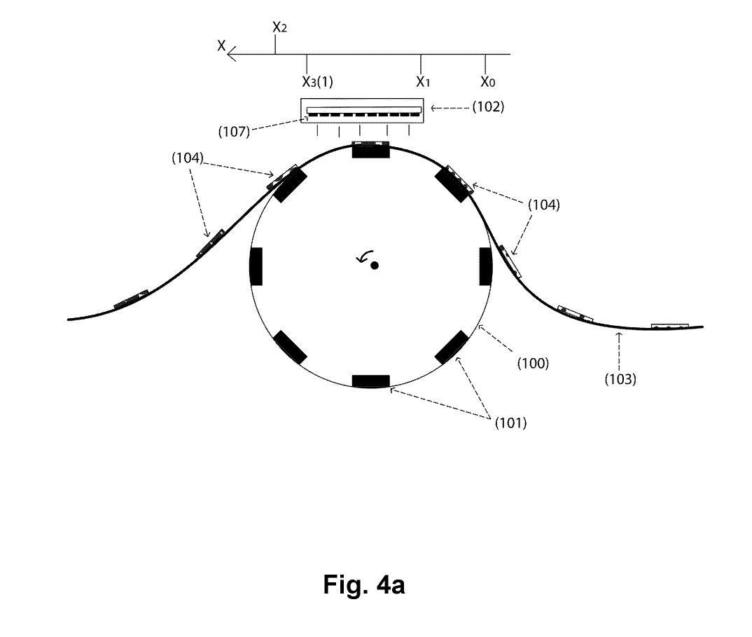

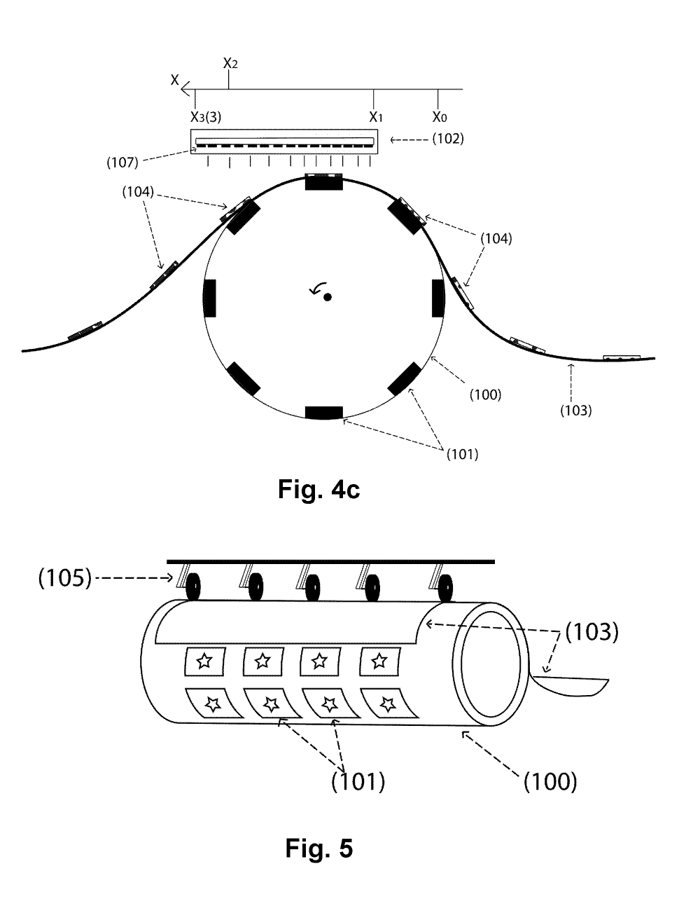

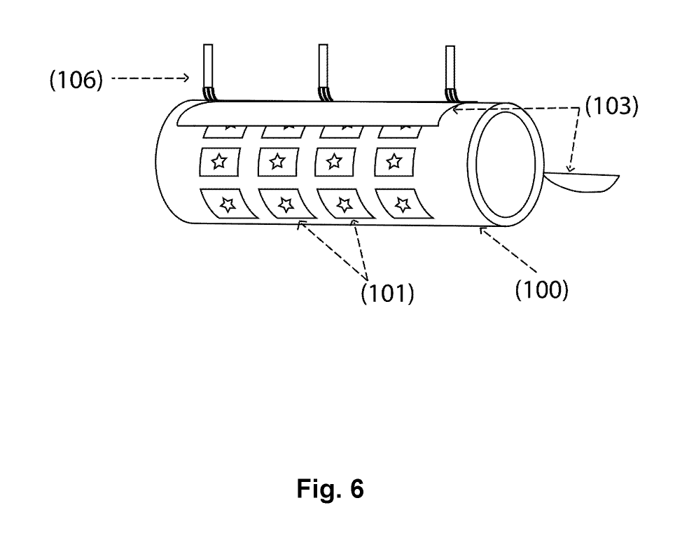

FIGS. 1 to 4a-c show preferred embodiments of the present invention, where the device for producing a magnetically induced visual effect by printing and curing of security or decorative features based on orientable magnetic particles comprises a photocuring unit positioned above a magnetic cylinder. FIGS. 5 and 6 show different preferred implementations of a substrate-guiding system holding the substrate (sheet) carrying the coating composition in close contact with the magnetic cylinder.

Here, the term “magnetic cylinder” refers to a cylinder body carrying at least one magnetic field generating element enabling the orientation of the magnetic particles to generate the visual effects. Such magnetic field generating elements have been described in e.g. EP 1,641,624, EP 1,937,415, US 2010/0,040,845 or WO 2004/007,095.

The one or more magnetic field generating elements used to orient the magnetic particles may be assembled from a wide range of magnetic material such as, but not limited to, neodymium-iron-boron, samarium-cobalt, aluminium-nickel-cobalt (alnico) alloys, ferrites or polymer bonded magnets such as magnetic foils or plastoferrites. Such materials are commercially available from e.g. the company Maurer Magnetic AG. Commercial product catalogs for magnetic materials typically indicate the maximum use temperature of the material. The maximum use temperature is material-dependant and is far below the Curie temperature of the material: for instance, for alnico alloys, the Curie temperature is around 850° C. and the maximum use temperature lies around 500° C. For hard-ferrite, the Curie temperature is around 450° C. and the maximum use temperature around 250° C. (see Maurer Magnetic AG catalog). For polymer bonded magnetic material, the maximum use temperature also depends on the polymer compound itself. Thus maximum use temperatures for plastoferrite are typically in the range of 80° C. to 100° C.

According to the present invention, the temperature of the magnetic cylinder body is limited to not exceed 100° C., and preferably, it is limited to not even reach the maximum use temperature of the magnetic material of the magnetic field generating elements. Thus, the average temperature of the magnetic cylinder body should remain below 100° C., preferably below 70° C., most preferably below 50° C. This is achieved by using a photocuring unit that is an appliance comprising a radiation source, which is configured such that its emission of thermal radiation energy during operation is limited such as to not heat the mechanical parts of the device, in this embodiment particularly the magnetic cylinder body and the magnetic field generating elements, to an average temperature T1 exceeding 100° C. More preferably, the photocuring unit is configured such that an average temperature of the mechanical parts of the device and of the magnetic field generating elements can be maintained during operation at a temperature T1≦100° C., or more preferably at a temperature T1≦70° C., or most preferably at a temperature T1≦50° C.

Thus, the photocuring unit is compatible with temperature sensitive magnetic materials and prevents registration and misalignments issues of the substrate with the magnetic field generating elements by means of avoiding changes of substrate dimensions caused e.g. by a decreased humidity content of said substrate and by means of avoiding thermal dilatation of the mechanical parts of the device.

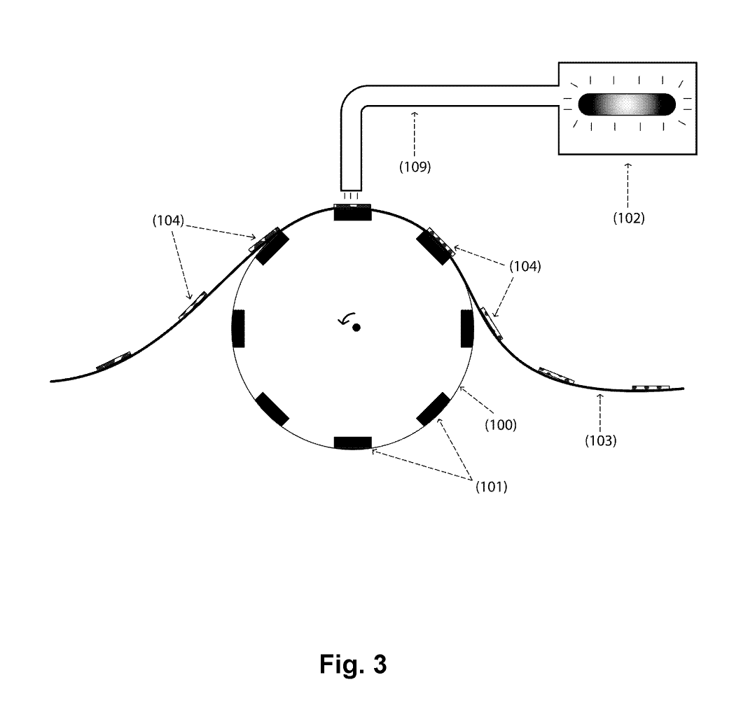

Particularly, the photocuring unit may comprise a UV-lamp, preferably a UV-LED lamp, as illustrated in FIG. 1. As shown in FIG. 2, the UV-lamp may be equipped with at least one dichroic reflector which is configured to direct the radiation corresponding to UV-spectra wavelengths towards the coated substrate and to direct the radiation corresponding to the IR-spectrum wavelengths away from the coated substrate. The photocuring unit may also be implemented as a UV lamp equipped with a waveguide directing the irradiation energy towards the coated substrate.

A large number of very different UV- and/or VIS-light sources are suitable as radiation sources of the photocuring unit, provided that the photocuring unit does not emit so much thermal energy towards the magnetic cylinder as to heat it above the temperature T1. To maintain the temperature of the cylinder body below T1 during irradiation, the light sources may for example require some dichroic reflectors set-up and/or some waveguide unit as described above.

Point sources, line sources and arrays (“lamp curtains”) are suitable radiation sources of the photocuring unit. Examples are carbon arc lamps, xenon arc lamps, medium-, super high-, high- and low-pressure mercury lamps, possibly with metal halide doped (metal-halogen lamps), microwave-stimulated metal vapour lamps, excimer lamps, super-actinic fluorescent tubes, fluorescent lamps, argon incandescent lamps, electronic flashlights, photographic flood lamps and lasers. Examples of lamps are known from the UV-lamps suppliers, e.g. the IST METZ group.

Preferred photocuring units comprise LED (light emitting diode) VIS- or UV-lamps, or mercury lamps equipped with a waveguide, or mercury lamps equipped with dichroic reflectors, with at least one said dichroic reflector directing the radiation corresponding to the UV-spectra wavelengths towards the coated substrate and at least one said dichroic reflector directing the radiation corresponding to the IR-spectrum wavelengths away from the coated substrate. Most preferred photo-curing units are LED UV-lamps as supplied from e.g. Phoseon Technology. Examples of dichroic reflector are known from the UV-lamps suppliers, e.g. the IST METZ group.

The photocuring unit may be used to either fully cure the coating composition containing the orientable magnetic plate-like particles, or alternatively, to only partially cure the coating composition to such a degree of viscosity as to prevent the oriented magnetic particles from completely or partially losing their orientation during and/or after the substrate has been removed from the magnetic cylinder. In the case of only partial curing of the coating composition, the curing is completed after the substrate has been removed for the magnetic cylinder by performing an additional thermal and/or photochemical treatment of the coating composition.

As used herein, the term “orientable magnetic particles” refers to particles, which can be oriented in a magnetic field so as to create a visual effect to be used as a security or as a decorative feature. Here, “orientable magnetic particles” are preferably magnetic non-spherical particles, more preferably magnetic acicular particles, most preferably magnetic plate-like particles.

Further, preferred orientable magnetic particles are particles which are also reflective. Herein, the term “reflective particles” refers to particles that produce effects of high reflectance. Particles achieving high reflectance have a high specular reflectance component across the visible spectrum, as described e.g. in EP 1,305,373 or in U.S. Pat. No. 7,449,239. Reflective particles are in particular metallic particles, as disclosed e.g. in U.S. Pat. No. 4,321,087, or U.S. Pat. No. 6,929,690; or reflective particles are interferential multi-layered plate-like particles as disclosed e.g. in U.S. Pat. No. 6,838,166.

As used herein, the term “orientable reflective magnetic particles” includes, but is not limited to, orientable optically variable magnetic plate-like particles as disclosed e.g. in WO 2003/000,801 or WO 2002//090,02, or orientable reflective magnetic particles as disclosed in U.S. Pat. No. 6,838,166.

Thus according to the present invention, the preferred orientable magnetic particles are orientable magnetic reflective plate-like particles. In the most preferred embodiment of the present invention, the orientable magnetic reflective plate-like particles are orientable magnetic reflective optically-variable plate-like particles.

Optionally, the coating composition of the present invention may contain a mixture of different orientable reflective magnetic particles, more preferably a mixture comprising at least one type of orientable reflective magnetic optically-variable plate-like particles. The magnetic inks to be used for the present application are known from e.g. WO-A 2003/000,801 or WO 02/073,250.

The coating composition may also optionally comprise, in addition to the orientable reflective magnetic particles or in addition to the mixture of different orientable reflective magnetic particles, further pigment particles selected from the group consisting of colored or colorless magnetic pigment particles, optically variable or colored or colorless non-magnetic pigment particles.

The coating composition may be formulated as described in WO 2007/131,833 or EP-B 2,024,451 and preferably it is applied by silkscreen printing, flexographic or gravure printing.

The orientation of the magnetic particles can preferably be performed through the application of correspondingly structured magnetic fields as known from WO 2004/007,095, WO 2005/002,866, WO 2008/009,569, or WO 2008/046,702.

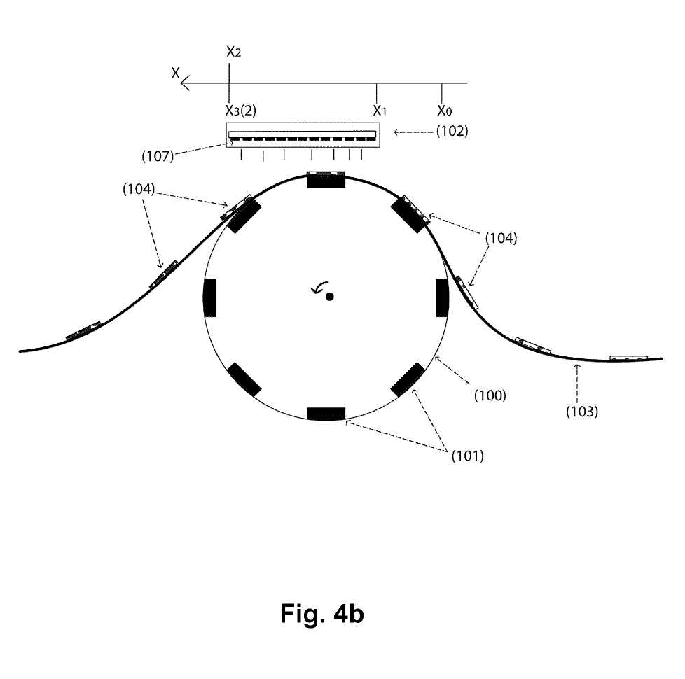

As illustrated in FIGS. 4a-c the process sequence for producing the magnetically induced visual effects can be defined by the following steps:
Before time t0: an image is printed with the coating composition comprising orientable magnetic particles on a first side of a substrate;
Time t0: the side of the substrate opposite to the printed image (104) is brought into contact with the orientation means comprising a magnetic element (101), the coating composition containing the orientable magnetic particles being still in a wet phase. Orientation of the magnetic particles starts at time t0.
Time t1: the irradiation of the printed image (104) by the photocuring unit starts. The time difference between t0 and t1 is the time required for the orientation of the magnetic particles to take place such as to create the security or decorative feature.
Time t2: t2 is defined as the time when the printed image (104) on the substrate is released from the orientation unit, i.e. here the magnetic cylinder body.
Time t3: the printed image on the substrate leaves the irradiation zone. The time t3 may be anterior, simultaneous or posterior to the time t2.

The photocuring unit may particularly be placed above the orientining means, i.e. in the illustrated embodiment above magnetic cylinder. Here, the photocuring unit being positioned “above” the magnetic cylinder means that the relative position of the photocuring unit and the magnetic cylinder are such that the irradiation of the printed image on the coated substrate occurs between the times t1 and t3.

In FIGS. 4a-c the position x0 is the abscissa corresponding to the location where the substrate (103) comes into direct contact with the cylinder body. The time t0 is the moment when a given printed image (104) on the substrate (103) is at position x0.

The position x1 is the abscissa corresponding to the location where the substrate enters in the irradiation zone. The time t1 is the moment when said printed image reaches position x1.

The position x2 is the abscissa corresponding to the location where the substrate gets released from the cylinder body. The time t2 is the moment when said printed image (104) is at position x2.

The position x3 is the abscissa corresponding to the location where the irradiation zone ends. The time t3 is the moment when a printed image is at position x3, meaning when the printed image leaves the irradiation zone.

The orientable magnetic particles of said printed image (104) start being oriented by the magnetic field generating elements (101) when the substrate (103) comes into contact with the cylinder body (100) at the coordinate x0 and at the time to.

When the image reaches the coordinate x1 at the time t1, the orientable magnetic particles are oriented according to optimum alignment of the visual feature and the curing is initiated by irradiation from the photocuring unit (102). When the substrate reaches the position x2, it gets released from the cylinder body (100).

The position x3 may be located in 3 different locations relative to x2: x3 is located either before x2 (x3(1), FIG. 4a), or x3 is at the same position as x2 (x3(2), FIG. 4b), or x3 is after x2 (x3(3), FIG. 4c). Correspondingly, the time t3 may be anterior, simultaneous or posterior to the time t2, depending on the configuration of the device.

The present invention is particularly advantageous for the printing and curing of coating compositions containing orientable magnetic plate-like particles on substrates prone to absorb the coating composition. As shown in FIGS. 4a-c, partial or complete drying (curing) of the coating composition can be performed immediately after orientation of the orientable magnetic plate-like particles. Thus, the coating composition remains wet for a much shorter period in the process according to the present invention compared to the state of the art process, as exemplified in e.g. WO 2004/007,095. Therefore, the absorption of the coating composition by the substrate may be strongly reduced.

As used herein, a “substrate-guiding system” refers to a set-up that holds the substrate (e.g. a sheet) in close contact with the orientation means, i.e. here the magnetic cylinder.

Usually in known printing machines, the substrate is maintained in close contact with the various printing cylinders by counter-pressure cylinders.

However, for the printing of orientable magnetic particles, no counter-pressure cylinder may be used on the magnetic cylinder while the ink on the substrate surface is still wet. Therefore, the substrate (sheet) may instead be held on the orienting means by a gripper and/or a vacuum system. Particularly, the gripper may serve the purpose of holding the leading edge of the sheet and allowing the sheet to be transferred from one part of the printing machine to the next, and the vacuum system may serve to pull the surface of the sheet against the surface of the orienting means and maintain it firmly aligned therewith. Nevertheless some mechanical problems related to the positioning of the substrate (sheet) on the magnetic cylinder may occur, in particular, if the substrate is a sheet, at the trailing extremity of sheet: the sheet may shift or slide either sideways or in the direction of the substrate motion, or the sheet may be folded on the cylinder, or the sheet may form a bulge on the cylinder, or the sheet may float, particularly at its edges.

Thus, according to a preferable further embodiment of the present invention, the substrate-guiding system may comprise, in addition to or instead of the gripper and/or the vacuum system other pieces of substrate-guiding equipment such as, without limitation, a roller or a set of rollers which may be narrow rollers (FIG. 5), a brush or a set of brushes (FIG. 6), a belt and/or a set of belts, a blade or a set of blades, or a spring or a set of springs.

The coating can be applied on a wide range of different substrates, including paper, opaque or opacified polymer substrates, and transparent polymer substrates. The present invention is particularly advantageous when using substrates that tend to absorb wet coating compositions. In particular the invention is beneficially used for the printing and curing of coating composition comprising orientable magnetic plate-like particles on paper used for banknotes or documents of value. The magnetically induced image in the coating can particularly be used as a security element for protecting a banknote or another document of value or as a decorative element to embellish an article.

1. A device for producing a magnetically induced visual effect, the device comprising:
a printing unit arranged to print with a coating composition containing orientable magnetic particles an image on a first side of a substrate;
an orientation means comprising at least one magnetic field generating element for orienting the magnetic particles in the coating composition of the printed image;
a substrate-guiding system arranged to hold a second side of the substrate in contact with the orientation means;
a photocuring unit comprising a radiation source arranged with respect to the orientation means so as to irradiate the image printed on the first side of the substrate to cure the coating composition of the image while the second side of the substrate is still in contact with the said orientation means;
characterized in that
the photocuring unit is configured such that its emission of thermal radiation energy towards the orientation means is limited such as to not heat the orientation means and its at least one magnetic field generating element to an average temperature (T1) exceeding 100° C.

2. The device according to claim 1, wherein said photocuring unit is further configured such that its emission of thermal radiation energy towards the orientation means is limited such as to not heat the orientation means and its at least one magnetic field generating element to an average temperature (T1) exceeding 70° C., or more preferably not exceeding 50° C.

3. The device according to claim 1 or 2, wherein the orientation means is a cylindrical body comprising at least one magnetic field generating element.

4. The device according to any one of the preceding claims, wherein said radiation source is a UV-lamp.

5. The device according to claim 4, wherein said UV-lamp is a LED UV-lamp.

6. The device according to any one of the preceding claims, wherein said photocuring unit (102) further comprises at least one first dichroic reflector directing the radiation of the radiation source corresponding to the UV-spectrum wavelengths towards the substrate and at least one second dichroic reflector directing the radiation of the radiation source corresponding to the IR-spectrum wavelengths away from the substrate.

7. The device according to any one of the preceding claims, wherein said photocuring unit (102) further comprises a waveguide for directing the radiation of radiation source towards the cylindrical body so as to irradiate the image printed on the first side of the substrate, while the second side of the substrate is in contact with the said cylindrical body.

8. The device according to any one of the preceding claims, wherein said substrate-guiding system comprises a gripper and/or a vacuum system.

9. The device according to any one of the preceding claims, wherein said substrate-guiding system comprises at least one substrate-guiding piece of equipment selected from the group consisting of a brush, a set of brushes, a roller, a set of rollers, a set of narrow rollers, a belt, a set of belts, a blade, a set of blades, a spring or a set of springs.

10. A system for producing a magnetically induced visual effect, the system comprising:
a device according to any one of claims 1 to 9; and
a coating composition containing orientable magnetic particles.

11. A method of producing a magnetically induced visual effect, the method comprising the steps of:
printing with a coating composition containing orientable magnetic particles an image on a first side of a substrate;
holding a second side of the substrate in contact with an orientation means generating a magnetic field;
orienting the magnetic particles in the coating composition of the printed image by the magnetic field of the orientation means;
irradiating the image by a curing unit to cure the coating composition containing the oriented magnetic particles at least partially while the second side of the substrate is still in contact with the cylindrical body;
characterized by
limiting the emission of thermal radiation energy by the curing unit such as to not heat the orienting means to an average temperature exceeding 100° C.

12. The method according to claim 11, wherein the coating composition containing the oriented magnetic particles is cured completely by irradiating the image by a curing unit while the second side of the substrate is still in contact with the cylindrical body.

13. The method according to claim 11 or 12, further comprising the step of removing the substrate from the orienting means at a time (t2) after the beginning of the irradiation step.

14. The method according to claim 13 wherein the irradiation of the printed image is stopped at a time (t3) anterior or simultaneous to the time (t2) when the substrate is removed from the orienting means.

15. The method according to claim 13 wherein the irradiation of the printed image is stopped at a time (t3) posterior to the time (t2) when the substrate is removed from the orienting means.

16. The method according to any one of claims 11 to 15 wherein the magnetically induced image is a security element for protecting a banknote or other document of value or a decorative element to embellish an article.

17. The method according to any one of claims 11 to 16, wherein said coating composition comprises at least one type of orientable magnetic particles being reflective and/or plate-like.

18. The method according to claim 17, wherein the orientable magnetic particles are optically-variable particles.

19. The method according to claim 17 or 18, wherein said coating composition contains in addition at least one of:
non-colour-shifting magnetic particles;
colourless magnetic particles;
colour-shifting non-magnetic pigment particles;
non-colour-shifting non-magnetic pigment particles;
colourless non-magnetic pigment particles.
